(19) United States
(12) Patent Application Publication
(10) Pub. No.: US 2007/0276637 A1
(43) Pub. Date: Nov. 29, 2007

(54) VISUAL OPTIMIZATION PROGRAMMING

(75) Inventors: John A. Allen, New Brighton, MN (US); Vipin Gopal, New Brighton, MN (US); James P. Richardson, St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/420,110

(22) Filed: May 24, 2006

(51) Int. Cl. G06F 17/10

(52) U.S. Cl. 703/2

(57) ABSTRACT

A method of determining a solution to a problem is provided. The method comprises defining a problem graphically using an entity-relationship modeling notation comprising at least one entity, at least one attribute, and at least one relationship, wherein the at least one entity and the at least on relationship are capable of being designated as a decision element. The method also comprises mapping the graphical modeling notation to algebraic form, and passing the algebraic form to a mathematical solver adapted to solve the algebraic form of the problem.

### BACKGROUND

Large-scale optimization is increasingly used to maximize performance of complex systems such as an aircraft fleet or an entire process plant. However, a major barrier to the use of mathematical optimization routines is the specification bottleneck. The specification bottleneck is a problem of communication between domain experts and optimization experts. Domain experts are those who are familiar with the requirements of a complex system. However, the domain experts often do not understand how to formulate a mathematical program for solving an optimization problem related to the complex system. Optimization experts are those who understand the mathematical programs, but do not usually understand the requirements of the complex system.

Currently, a domain expert has to become an optimization expert and/or an optimization expert has to become a domain expert due to the relatively cryptic mathematical programs which bear little obvious connection to the problem as understood by the domain expert. This training requires large amounts of time and/or money as domain experts and optimization experts work to understand the other side of the specification bottleneck.

For the reasons stated above, and for other reasons stated below which will become apparent to those skilled in the art upon reading and understanding the present specification, there is a need in the art for a method and system of modeling/solving optimization problems in order to alleviate the specification bottleneck.

### SUMMARY

The above-mentioned problems and other problems are resolved by the present invention and will be understood by reading and studying the following specification.

In one embodiment, a method of determining a solution to a problem is provided. The method comprises defining a problem graphically using an entity-relationship modeling notation comprising at least one entity, at least one attribute, and at least one relationship, wherein the at least one entity and the at least on relationship are capable of being designated as a decision element. The method also comprises mapping the graphical modeling notation to algebraic form, and passing the algebraic form to a mathematical solver adapted to solve the algebraic form of the problem.

In another embodiment, a system for determining a solution to a problem is provided. The system comprises a display element adapted to display graphical modeling notation and at least one user input element adapted to receive user input in defining a problem using the graphical modeling notation. The system also comprises a processing unit coupled to the display element and to the at least one user input element. The processing unit is adapted to send display signals to the display element to display the problem using the graphical modeling notation based on input received from the user input element. The processing unit is further adapted to map the graphical modeling notation of the problem to algebraic form, wherein at least one of an entity and a relationship in the graphical modeling notation are designated as a decision element based on user input.

In another embodiment, a computer program product comprising a computer-usable medium having computer-readable code embodied therein for configuring a computer processor is provided. The computer-readable code comprises first executable instructions configured to cause a computer processor to map a problem described using graphical modeling notation to algebraic form, wherein at least one of an entity and a relationship in the graphical modeling notation is designated as a decision element. The computer-readable code also comprises second executable instructions configured to cause a computer processor to pass the algebraic form to a mathematical solver adapted to determine a solution to the algebraic problem

### DRAWINGS

FIG. 1 is a diagram describing an optimization problem using a graphical modeling notation according to one embodiment of the present invention.

FIG. 2 is another diagram describing an optimization problem using a graphical modeling notation according to one embodiment of the present invention.

FIG. 3 is another diagram describing an optimization problem using a graphical modeling notation according to one embodiment of the present invention.

FIG. 4 is a high level block diagram of a visual optimization programming system according to one embodiment of the present invention.

FIG. 5 is a flow chart of a method of solving an optimization problem using graphical modeling notation according to one embodiment of the present invention.

FIG. 6 is a flow chart showing a method of generating an entity key according to one embodiment of the present invention.

FIG. 7 is a flow chart showing a method of generating a relationship key according to one embodiment of the present invention.

FIG. 8 is a prior art diagram for representing an optimization problem.

FIG. 9 is another diagram describing an optimization problem using a graphical modeling notation according to one embodiment of the present invention

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should also be understood that the exemplary methods illustrated may include additional or fewer steps or may be performed in the context of a larger processing scheme. Furthermore, the methods presented in the drawing figures or the specification are not to be construed as limiting the order in which the individual steps may be performed. The following detailed description is, therefore, not to be taken in a limiting sense.

Embodiments of the present invention provide a solution to the specification bottleneck in applying optimization problems to specific systems. This solution is provided by enabling domain experts to express optimization problems in terms understood by the domain expert. In particular, the optimization problem is expressed using graphical modeling notation familiar to the domain expert, such as Unified Modeling Language, Logic Data Structures, etc, and functional notation that references the elements of the modeling notation diagrams. Embodiments of the present invention map or convert the expression of the problem, as created by the domain expert, to algebraic form. In particular, embodiments of the present invention are adapted to enable expression and conversion of both linear programming (LP) and mixed integer-linear programming (MILP) optimization problems. The algebraic form call then be passed to commercially-available mathematical solver to solve the optimization problem. Hence, the specification bottleneck is avoided by eliminating the need for a domain expert to become an optimization expert.

As mentioned above, embodiments of the present invention are adapted to handle both LP and MILP optimization problems. A typical LP and MILP problem definition consists of index sets and variables, parameters, decision variables, constraints, and an objective. An index set is a finite mathematical set whose elements typically correspond to real-world objects. An index variable is a variable bound to an index set. For example, the following is a group of index variables and sets,
Aircraft={N291US, N296US, N299US}
Station={SFO, JFK, BOS}
Flight={NW23, NW144, NW729}

In the above group, Aircraft, Station, and Flight are all index variables tied to their respective index sets (i.e. {N291US, N296US, N299US}, {SFO, JFIK, BOS}, and {NW23, NW144, NW729}, respectively). A parameter is a quantity whose value is given as a part of the problem statement. Parameters are related to index variables and sets in that a parameter has zero or more index variables as subscripts. For example, departure Time_{f} is a parameter representing the departure time of flight f. Therefore, in this example, the value of departureTime_{f} will change according to the particular instance (or value) of index variable f. Additionally, explicit mathematical constants may be used wherever parameters are used.

A decision variable represents a quantity whose value is to be determined as part of the problem solution. A decision variable, like a parameter, has zero or more subscripts. For LP problems, all decision variables are real-valued. For MILP problems, a decision variable may be real-valued or integer-values. For example, in a common special case, a decision variable is binary-valued, i.e. restricted to values 0 and 1. A constraint is an equality or inequality among the problem's parameters and decision variables. For typical LP and MILP problems, constraints take the form of:

$$∀ I {\sum }_{J} {p}_{A} {v}_{B} \{ \begin{matrix}\leq \\ = \\ \geq \end{matrix} \} {q}_{C} ,$$

where I is a set of zero or more index variables over which the constraint is universally quantified, J is a set of zero or more index variables over which the summation is performed (If J is empty, there is no stuimnation), p_{A} and q_{C} are parameters, v_{B} is a decision variable, and A, B, and C are sequences of zero or more index variables or index values appropriate for the decision variable or parameter. An objective is simply a statement of the form “maximize v” or “minimize v” for some decision variable v. Described below are examples of an optimization problem represented using a graphical modeling notation and methods of converting or mapping the graphical model to algebraic form.

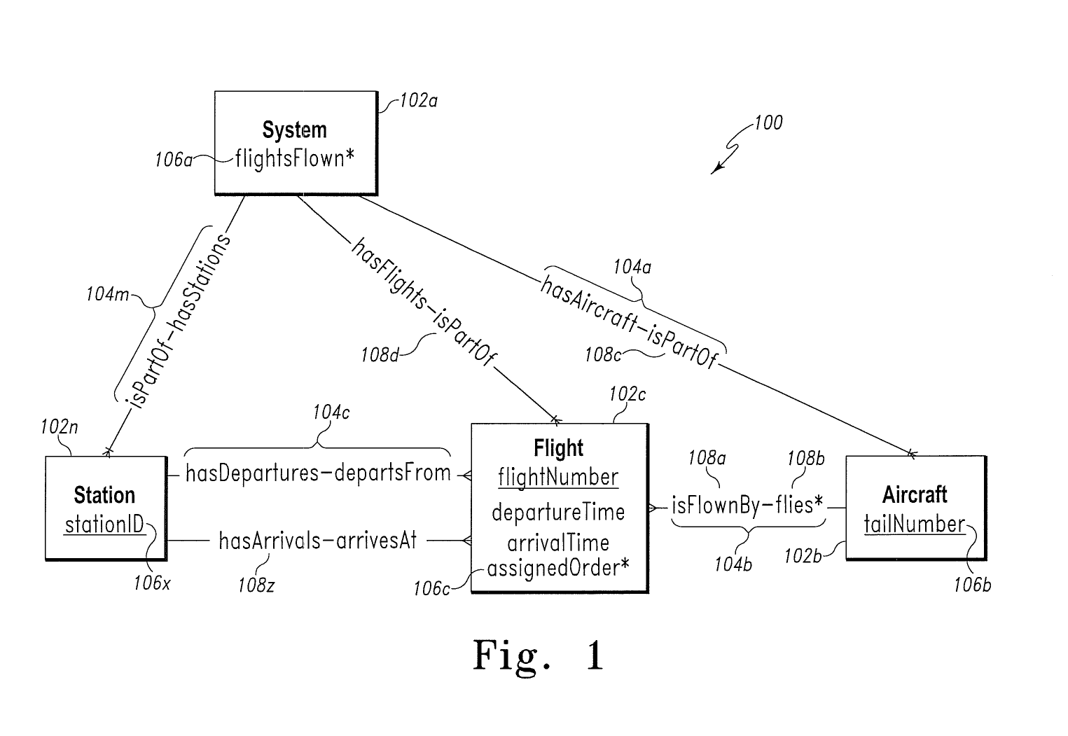

FIG. 1 is a diagram 100 describing an optimization problem using a graphical modeling notation according to one embodiment of the present invention. The optimization problem represented in diagram 100 concerns assignment of aircraft to particular flights such that the maximum possible number of flights is flown. It will be understood by one of skill in the art, however, that this optimization problem is provided by way of example and not by way of limitation. In particular, it is to be understood that other types of optimization problems are implemented in other embodiments of the present invention. Diagram 100 consists of entities 102a-102n, relationships 104a-104m, attributes 106a-106x, and links 108a-108z where n is the total number of entities, m is the total number of relationships, x is the total number of attributes, and z is the total number of links. The graphical modeling notation used in this example is Logic Data Structures (LDS). However, it is to be understood that, in other embodiments, other standard graphical modeling notations are used, such as Unified Modeling Language (UML).

An entity, as used herein, is an object, concept, or event relevant to the optimization problem and about which data is collected. An entity can be though of as a noun, i.e. a person, place, thing or concept. For example, an entity can be employees, projects, cities, etc (an entity instance is a specific entity value, e.g. Los Angeles). An attribute describes a property of the entity to which it is associated. For example, gender, height, and social security number, etc. Some attributes are identifying attributes in that the value of the attribute uniquely identifies the entity instance to which it is associated. For example, a social security number attribute uniquely identifies an employee instance, whereas gender and height are non-identifying attributes because they do not uniquely identify the employee entity instance. Relationships are made up of two links and describe an association between two entities or a recursive association of an entity with itself. Links, and consequently relationships, can be thought of as verbs. Links describe how the entities are related. For example, an employee entity works on a project entity and a project entity is assigned to an employee. The two links in this example, works on and is assigned to make up the relationship between the employee entity and the project entity.

Entities 102a-102n are shown in FIG. 1 as rectangles. However, in other embodiments, other shapes are used to depict entities 102a-102n, e.g. aircraft symbols are used to represent aircraft, etc. Each entity is labeled with a name in bold type. For example, entity 102a is labeled as “System” and entity 102b is labeled as “Aircraft”. Although four entities are used in the embodiment in FIG. 1, it is to be understood that, in other embodiments, any appropriate number of entities is used.

Each of entities 102a-102n, in this example, has at least one attribute 106a-106x which defines characteristics of a given instance of entities 102a-102n. For example, entity 102b has one attribute 106b called “tailNumber,” while entity 102c has 4 attributes called “flightNumber,” “departureTime, ” “arrivalTime,” and “assignedOrder.” (assignedOrder represents the position of a particular flight in the list of flights flown by the same aircraft). However, in other embodiments, ail entity may have no attributes and is identified by its relationships with other entities.

An attribute value is a specific value of the attribute for a particular instance of the entity. In addition, each of entities 102a-102n is connected to at least one other entity by at least one relationship 104a-104m. As mentioned above, a relationship is an association between two entities, and is indicated by a line in FIG. 1. For example, relationship 104b associates entity 102b with entity 102c and represents the assignment of aircraft to flights. A relationship instance is an association between two instances of the associated entities. Hence, a relationship instance (N291US, NW23) indicates that aircraft N291US is assigned to flight NW23.

Each relationship 104a-104m has two links, which are the interpretations of the relationship in each direction. For example, link 108a indicates that a flight isFlownBy an aircraft, and link 108b indicates that an aircraft flies a flight. Link values are the corresponding concept at the instance level and correspond to sets. Therefore, given the relationship instance example above, the value of link 108a for flight instance NW23 is {N291US}, whereas the link value of link 108b for aircraft instance N291US may be {NW23, NW144}, indicating that this aircraft is assigned to fly both flights. In particular, the modeling notation in this example indicates the maximum degree of a link (i.e. the largest allowable size of the set.)

In this example, using Logic Data Structures (LDS), the possible choices of maximum degree are one and infinity. A maximum degree of one is indicated by a simple line end on a relationship 104a-104m. A maximum degree of infinity is indicated by a “chicken foot” or “crowfoot” on a line end of a relationship 104a-104m. For example, link 108a of relationship 104b has a simple line end at entity 102b, indicating that each instance of a flight is flown by at most one aircraft. In addition, link 108b of relationship 104b has a “chickenfoot” line end at entity 102c, indicating that each instance of an aircraft may fly zero or more flights. Hence, relationship 104b represents a one-to-many relationship between aircraft and flights. Although, the present example only allows for a maximum degree of one or many, it is to be understood that, in other embodiments, other models allow for the specification of other values for maximum degree and allow for the specification of minimum degree as well.

Since attributes 106a-106x and links 108a-108z are similar, the more general term “descriptor” is often used to refer to either a link or an attribute. Similarly, a descriptor value is an attribute value or a link value. In addition entities 102a-102n, attributes 106a-106x, relationships 104a-104m, and links 108a-108z all have names. A relationship's name, in this embodiment, is the concatenation of its two link names. For example relationship 104b is named “isFlownByFlies.” The mapping approach described below requires that no two entities 102a-102n or relationships 104a-104m have the same name, and that no two descriptors (links 108a-108z and attributes 106a-106x) of the same entity have the same name.

Entities 102a-102n are uniquely identified by an identifier. An identifier is a minimal set of an entity's descriptors that are sufficient to distinguish one instance of the entity from another. If the identifiers for entities 102a-102n consist solely of attributes, then each instance of entities 102a-102n is identified by the values for those attributes. However, if an entity identifier includes one or more links, then instances of the corresponding entity is partly or entirely identified by instances of other entities. The identifiers for entities 102a-102n, in this embodiment, are indicated graphically by bars that underline attributes and cross through the near ends of relationship lines. For example, “flightNumber” in entity 102c and “tailNumber” in entity 102b are identifying attributes. Also, each of entities 102b, 102c and 102n, in this example, have a cross bar in the near end of a relationship associating each entity to entity 102a. Hence, the identifier for entity 102c includes link and is {flightNumber, isPartOf}. Similarly, the identifier for entity 102b includes link 108c and is {tailNumber, isPartOf). In other embodiments, system entity 102a is not included. In such embodiments, the identifier for entities 102c and 102b would be simply the respective identifying attributes {flightNumber} and {tailNumber}. Identifying attributes correspond to index variables in the algebraic expression discussed above. Hence, each identifying attribute has an enumerated data type with known possible values. Non-identifying attributes correspond to parameters and decision variables, so each may be of data type real, integer, or binary depending on the particular embodiment and application.

Embodiments of the present invention can designate an entity (e.g. entities 102a-102n), a non-identifying relationship (e.g. relationship 104b) or a non-identifying attribute (e.g. attribute 106c) as a decision element. In this example embodiment, decision elements are marked by an asterisk. For example, relationship 104b, attribute 106c, and attribute 106a are all marked with an asterisk indicating that each is a decision element. Designating a non-identifying attribute as a decision element means that the attribute's value must be determined. The set of possible values is determined by the attribute's type (e.g. real, integer, or binary). Designating an entity or a non-identifying relationship as a decision element means that the solution must state which instances of the model element exist, among all the possible instances. The ability to define an optimization problem in which the existence of an entity or relationship instance is to be determined goes beyond the prior art where only attribute values may be determined.

In this example, some constraints on the optimization problem are expressed as part of the modeling notation. For example, the constraint that a given flight may only be assigned to at most one aircraft is expressed by the use a simple line ending as described above. However, other constraints are expressed using a functional notation. In particular, a constraint to define the decision variable and each flight's assigned order are defined, in this example, using a functional notation. For example, the constraint defining the decision variable in this example is given as: System.flightsFlown=count(System.hasAircraft.flies). The left hand of the expression references the single instance of entity 102a and the decision attribute 106a. The right hand of the expression navigates from this instance to the set of instances of entity 102b (i.e. aircraft), and from there to the set of instances of entity 102c (i.e. flights) that have been assigned to the aircraft. The size of this set of instances is computed by the count function.

The constraints are Boolean expressions that references elements of the diagram 100. In particular the Boolean expression, in this example, can be formed from one or more equalities between numeric expressions (e.g. Flight[fn1].assignedOrder=Flight[fn2].assignedOrder-1), inequalities between numeric expressions (e.g. Flight[fn1].arrivalTime<=Flight[fn2].departureTinme), equalities between single-valued entity references (e.g. Flight[fn1].flies=Flight[fn2].flies) and relationship references (e.g. IsFlownByFlies[flightNumber, tailNumber]). Additionally, in this example, a term in a numeric expression can be one of a numeric constant, a single valued attribute reference, the count function applied to an entity reference, and the sum function applied to an attribute reference. The functional notation used to express constraints not contained in the diagram 100 is relatively easier to understand than the algebraic form.

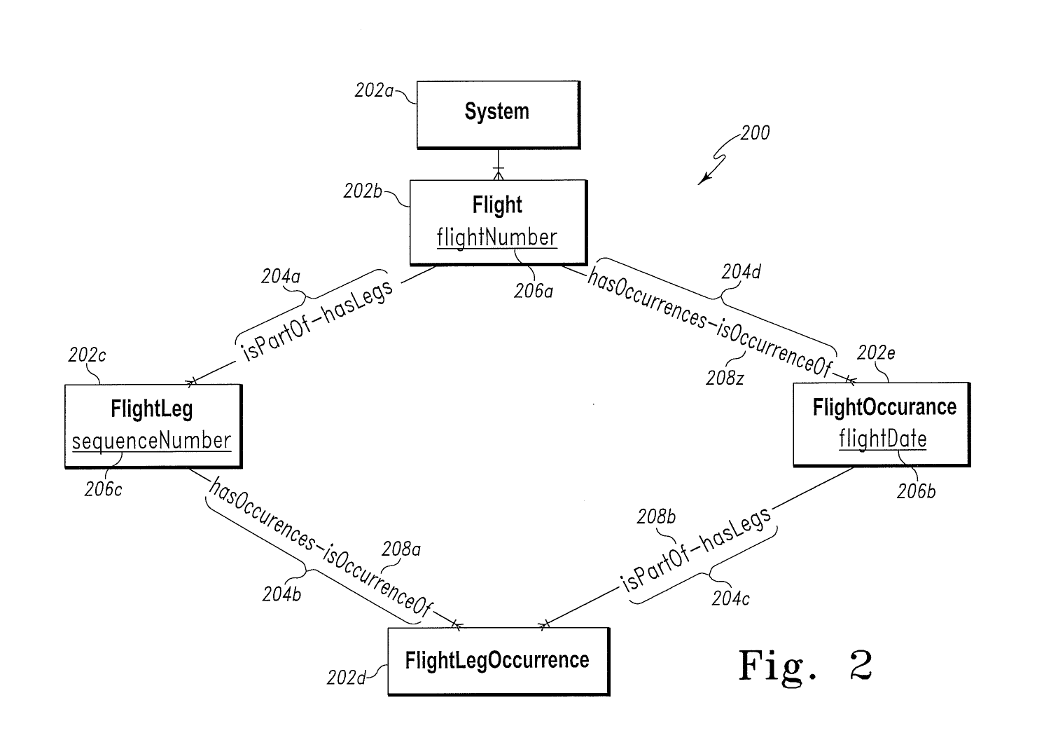

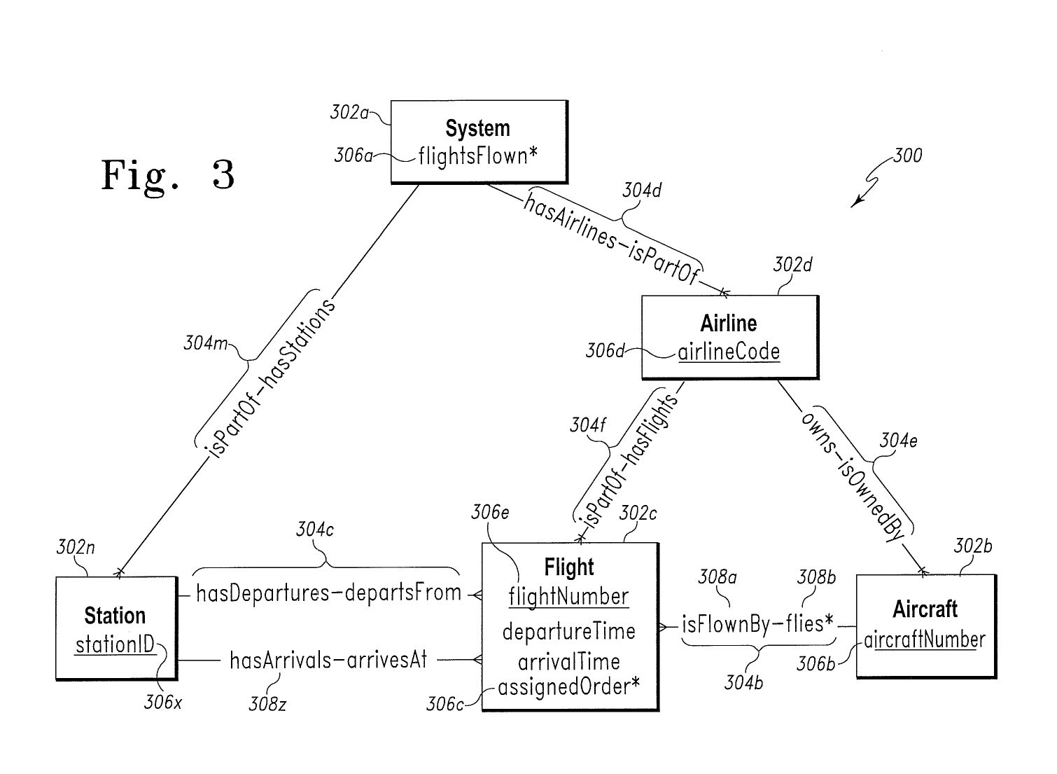

Additionally, in order to ensure that entities 102a-102n and relationships 104a-104m are uniquely identified, some embodiments of the present invention impose one or more of the following constraints: 1) each entity (other than system entity 102a) must have exactly one identifier, 2) Each identifier must include at least one link, 3) If a link is part of an identifier, its maximum degree must be one, and 4) the directed graph defined by entities 102a-102n and identifying links (e.g. links 108c and 108d) must contain no cycles. Some embodiments do not use all 4 constraints. For example, in some embodiments, an entity has more than one identifier. Also, even if the constraint requiring identifiers to include a link is used, this requirement is satisfied by using a link referencing system entity 102a as in the embodiment in FIG. 1. In many cases, these requirements ensure that instances of entities 102a-102n and relationships 104a-104m are each uniquely identified. However, in some cases, the model must contain additional information not shown in diagram 100 to ensure proper identification of instances of entities 102a-102n and relationships 104a-104m, examples of which are described in more detail below with regards to FIGS. 2 and 3.

FIG. 2 is a diagram 200 describing an optimization problem using a graphical modeling notation according to one embodiment of the present invention. Diagram 200 includes entities 202b, 202c, 202d and 202e. Entity 202b represents instances of flights published in an airline's flight schedule. Entity 202c represents instances of one part of a flight (flight leg) involving a single takeoff and landing. Entity 202d represents occurrences of a particular flight leg instance on a particular day. Entity 202e represents occurrences of a particular flight instance on a particular day. The information not contained in diagram 200 is that for every FlightLegOccurrence instance of entity 202d, the Flight instance of entity 202b corresponding to the FlightLeg instance of entity 202c and to the FlightOccurrence instance of entity 202e are the same Flight instance. This information is expressed, in this embodiment, as an identity constraint. An identity constraint has the form:
Entity: link₁₁. . . . .link₁ₙ=link₂₁. . . . .link₂ₘ

In particular, the identity constraint of diagram 200 is expressed as:
FlightLegOccurrence: isOccurrenceOf.isPartOf=isPartOf.isOccurrenceOf

Each side of the identity constraint is a sequence of links (e.g. link 208a and 208b) that starts at entity 202d (the source entity) and navigates via identifying links to entity 202b (the destination entity). Each link is part of its entity's identifier and both path expressions have the same destination entity. Intuitively, it means that if you start from a specific instance of the source entity and navigate by either sequence of links, you will arrive at the same instance of the destination entity. Identity constraints are sometimes needed for relationships also, as described below in regards to FIG. 3.

FIG. 3 is a diagram 300 describing an optimization problem using a graphical modeling notation according to one embodiment of the present invention. Diagram 300 is similar to diagram 100 but includes entity 302d and relationships 304e, 304f, and 304d. In this example, instances of airlines represented by entity 302d own aircraft and have flights (as represented by relationships 304e and 304f, respectively). In this example embodiment, the flights of each airline instance are always flown by aircraft owned by that airline instance. Hence, an identity constraint is needed to indicate this restriction. As with entity identity constraints described above with respect to FIG. 2, each side of a relationship identity constraint starts at a source relationship (e.g. 304b) and navigates via links (e.g. links 308c and 308d) to a destination entity (e.g. entity 302d). The form of a relationship identity constraint is of the form:
Relationship: link₁₁. . . . .link₁ₙ=link₂₁. . . . .link₂ₘ

In particular, the constraint in this example is expressed by the functional notation:
IsFlownByFlies: isFlownBy.isPartOf=flies.isOwnedBy

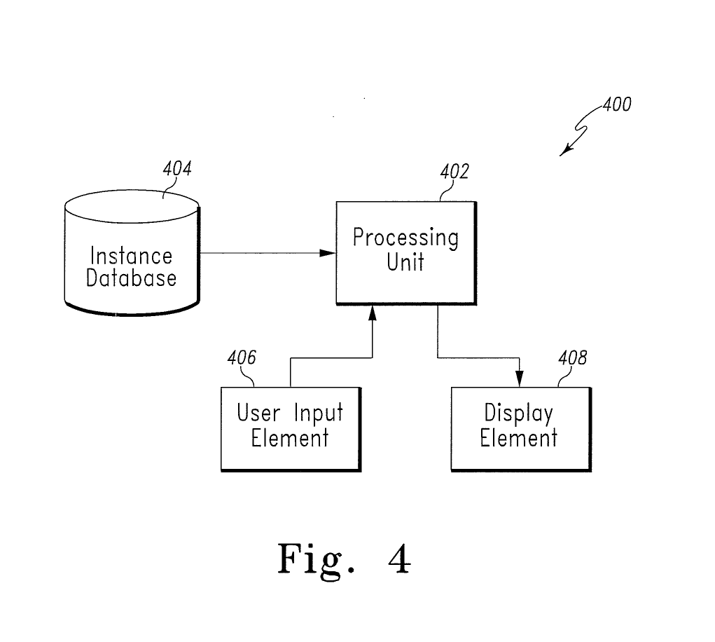

FIG. 4 is a high level block diagram of a visual optimization programming system 400 according to one embodiment of the present invention. System 400 is used to express optimization problems in a graphical model notation. A user creates a graphical data model representing an optimization problem, such as diagram 100 in FIG. 1, by inputting data through user input element 406. User input element 406 includes, but is not limited to, keyboards, touch screens, microphones, cursor control devices, line select buttons, etc. In some embodiments, user input element 406 comprises more than one type of input element. Processing unit 402 receives input data regarding a data model from user input element 406 and sends signals to display element 408 to display graphic representations of the data model.

A user can then modify, add to and delete from the data model through the interaction of user input element 406, processing unit 402 and display element 408. The user uses the graphical modeling notation to define the entities, attributes, relationships, and constraints, such as described above with regards to FIGS. 1-3. In particular, embodiments of the present invention enable the user to use user element 406 to define the optimization problem using a familiar modeling notation such as LDS or UML. In addition, embodiments of the present invention enable the user to designate not only attributes as decision elements, but also relationships and entities. Once the user has finished defining the optimization problem, the user sends a signal to processing unit 402 via user input element 406 instructing processing unit 402 to solve the optimization problem. Processing unit 402 then maps the data model to one of a LP and MILP algebraic form.

Additionally, processing unit 402 retrieves instance data. In some embodiments, the instance data is retrieved from explicit user input via user input element 406 when defining the optimization problem. However, in this example embodiment, processing unit 402 retrieves the instance data from relational database 404. Processing unit 402 then uses a commercially available mathematical optimization package, such as GAMS/CPLEX, to solve the optimization problem. In some embodiments, processing unlit 402 is implemented through a processor and computer readable instructions. In such embodiments, instructions for carrying out the various methods, process tasks, calculations, control functions, and output of data are implemented in software programs, firmware or computer readable instructions. These instructions are typically stored on any appropriate medium used for storage of computer readable instructions such as floppy disks, conventional hard disks, CD-ROM, flash memory ROM, nonvolatile ROM, RAM, and other like medium.

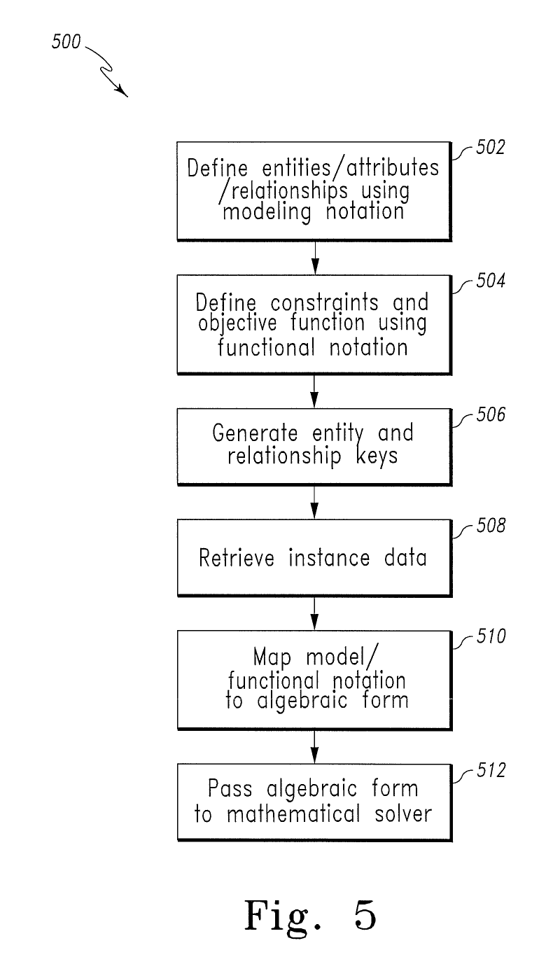

FIG. 5 is a flow chart of a method 500 of determining a solution to an optimization problem using graphical modeling notation according to one embodiment of the present invention. At 502, a user used a user input element (such as user input element 402) to define entities, attributes and relationships relevant to an optimization problem using a graphical modeling notation (such as UML and LDS), as described above with regards to FIGS. 1-4. Defining entities, attributes, and relationships includes designating decision elements. In embodiments of the present invention, entities, attributes and relationships can each be designated as a decision element. This is a major advantage over prior art which only allows for designation of attributes as decision elements.

At 504, constraints not defined by the graphical modeling notation are defined by the user using a functional notation. Such constraints include identity constraints, such as identity constraints described above with regards to FIGS. 2 and 3. The user defines these constraints via the user input element. In addition, the objective function is described using functional notation. In this example embodiment, the objective function is simply a statement of the form “maximize v” or “minimize v,” as described above. For example, the objective function for the exemplary model in FIG. 1 is “maximize fightsFlown.”

As described above with regards to FIG. 1, links are allowed in identifiers which makes the model (e.g. diagram 100) easier to understand and more precise. However, in order to reference entities and relationships in constraints, embodiments of the present invention need to be able to identify entity and relationship instances using attribute values alone. To that end, entity and relationship keys are generated by a processing unit, such as processing unit 402, at 506 when a user indicates that the problem is ready to be solved. A key is a sequence [k₁, . . . , kₙ], where each element kᵢ of the key is of the form linkᵢ₁. . . . .linkᵢₙ.attrᵢ for some n≧0. The sequence of links starts at the source entity or relationship to which the key applies, and navigates via identifying links to some destination entity that has attribute attrᵢ as an identifying attribute. Entity and relationship keys are similar to keys in relational databases. However, embodiments of the present invention also address identity constraints and their effects in generating entity and relationship keys, while other key generation methods do not.

At 508, instance data for non-decision elements is retrieved. For each entity and non-identifying relationship, the set of instances are provided and consist simply of a set of key value sequences. For each non-identifying attribute, the value(s) are provided, along with the key value sequence that identifies the instance to which the attribute value(s) apply. In some embodiments, the instance data is provided explicitly via the user input element as part of the problem statement when defining the optimization problem. In other embodiments, the instance data is retrieved from a relational database, such as database 404, or similar source.

At 510, the processing unit maps the model and functional notation to algebraic form. In this example embodiment, mapping the model and functional notation includes mapping each enumerated data type used by an identifying attribute to an index set and mapping each decision entity to a binary decision variable. In addition, non-identifying relationships are mapped to one of a binary decision variable or parameter based on designation of the relationship as a decision element or not. The parameter values are defined by the instance data. A value of 1 indicates that a relationship exists between the associated entity instances and a value of 0 indicates that the relationship does not exist. Similarly, each decision attribute is mapped to a decision variable of the same type and other non-decision non-identifying attributes are mapped to parameters of the same type. The values of the parameters are again defined by the instance data. The decision variables and parameters have index variables corresponding to elements of the key of the entity for which the attribute is defined.

In addition, in this example, non-decision entities are mapped to binary parameters, where the parameter values are defined by the instance data. However, in other embodiments, the non-decision entities are not mapped. The identifying relationships between two entities are mapped implicitly and represented by the subscripts that the two entities have in common. In addition, the processing unit generates constraints. For example, for each non-identifying link that has maximum degree one, a constraint is generated to enforce the maximum degree. Similarly, for each identifying link, a constraint is generated to enforce referential integrity. In other words, for every instance of an entity whose identifier references a second entity, there must be a corresponding instance of the second entity. Likewise, for each non-identifying relationship, two referential integrity constraints are generated to ensure that relationship instances link only entity instances that actually exist.

In some embodiments, constraints only reference parameters and not decision variables. In such embodiments, the constraints serve as integrity checks on the instance data. However, in other embodiments, a referential integrity constraint may force the existence of a particular instance of a decision entity because instance data indicates that a dependent entity or relationship instance exists. Various techniques are known to one of skill in the art for mapping a Boolean constraint to an LP or MILP constraint. However, unique to embodiments of the present invention is the mapping of constraints dealing with entity references that include link names.

Entity references consist of an entity name, qualified by a sequence of key variables and/or explicit key values, followed by zero or more link names. If any of the links as a maximum degree of infinity, the entity reference is multi-valued, otherwise it is single-valued. A constraint is implicitly universally quantified over all possible values of all key variables appearing in the constraint. Similarly, an attribute reference consists of an entity reference followed by an attribute name. The attribute value is single- or multi-valued, depending on the entity reference.

In this example embodiment, mapping a constraint dealing with entity references that include link names, each link traversal results in a summation over the key variable(s) of the destination entity. For example, the constraint Flight[flightNumber].assignedOrder>=count(Flight[flightNumber].isFlownBy includes the link isFlownBy. This constraint states that each flight's assigned order must be at least 1 if the flight is assigned to an aircraft. The Boolean constraint above is mapped, in this example, as assignedOrder[flightNumber]>=sum(Flight[flightNumber]*IsFlownByFlies[flightNumber, tailNumber], tailNumber).

At 512, the algebraic form is passed to a commercially available mathematical solver, such as GAMS/CPLEX. In this example embodiment, the processing unit itself uses the mathematical solver to solve the optimization problem. However, in other embodiments, the processing unit passes the algebraic form to another processing unit for processing with the mathematical solver. A portion of the algebraic form for diagram 100 in FIG. 1, is shown below:

```
index set tailNumber = [N291US, N296US, N299US]
index set stationID = [SFO, JFK, BOS]
index set flightNumber = [NW23, NW144, NW729]
binary parameter System = 1
integer variable flightsFlown
binary parameter Station[stationID] = [1,1,1]
binary parameter Flight[flightNumber] = [1,1,1]
binary parameter Aircraft[tailNumber] = [1,1,1]
real parameter departureTime[flightNumber] = [/*instance
data*/]
real parameter arrivalTime[flightNumber] = [/*instance
data*/]
integer variable assignedOrder[flightNumber]
binary parameter
  HasDeparturesDepartsFrom[stationID, flightNumber] =
[/*instance data*/]
binary parameter
  HasArrivalsArrivesAt[stationID, flightNumber] = [/*instance
data*/]
binary variable IsFlownByFlies[flightNumber,tailNumber]
constraint /* max degree constraint */
  sum(IsFlownFlies[flightNumber,tailNumber],tailNumber)
    <= 1
constraint /* referential integrity constraint */
  IsFlownByFlies[flightNumber,tailNumber]
    <= Aircraft[tailNumber]
constraint /* referential integrity constraint */
  IsFlownByFlies[flightNumber,tailNumber]
    <= Flight[flightNumber]
/* other referential integrity constraints omitted for
brevity */
```

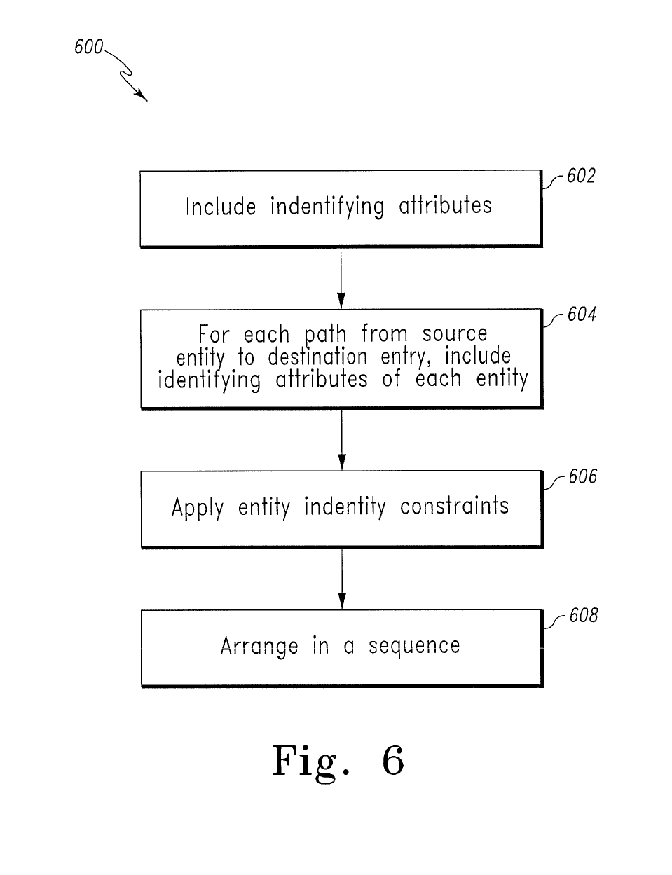

FIG. 6 is a flow chart showing a method 600 of generating an entity key according to one embodiment of the present invention. At 602, the identifying attributes, if any, of the source entity are included as elements of the key. For example, entity 202d in FIG. 2 has no identifying attributes, so this step contributes no elements for entity 202d. However, for entity 202c in FIG. 2, identifying attribute 206c would be included for entity 202c. At 604, for each path from the source entity to the destination entity, an identifying attribute of every intermediate entity in the path is included. For example, for entity 202d in FIG. 2, there are two paths to system entity 202a, the destination entity in this example. The first path contributes identifying attributes 206c (isOccurrenceOf.SequenceNumber) and 206a (isOccurrenceOf.isPartOf.flightNumber). Notably, the link(s) indicating the direction of the path is included in the key element with the identifying attribute. The second path contributes identifying attributes 206b (isPartOf.flightDate) and 206a (isPartOf.isOccurrenceOf.flightNumber). At 606, identity constraints, if any, are applied. With regards to FIG. 2, the identity constraint discussed above is isOccurrenceOf.isPartOf=isPartOf.isOccurrenceOf. This implies that the elements isOccurrenceOf.isPartOf.flightNumber is equal to isPartOf.isOccurrenceOf.flightNumber. Therefore, one of the two is eliminated. At 608, the remaining key elements are arranged in a sequence. Any sequence is acceptable. However, for clarity, the elements in this example are arranged with the attributes closest to the destination entity first. With regards to FIG. 2, the key elements for entity 202d are therefore, [isOccurrencOf.isPartOf.flightNumber, isOccurrenceOf.SequenceNumber, isPartOf.flightDate]. This key sequence will uniquely identify entity 202d based on attribute values alone.

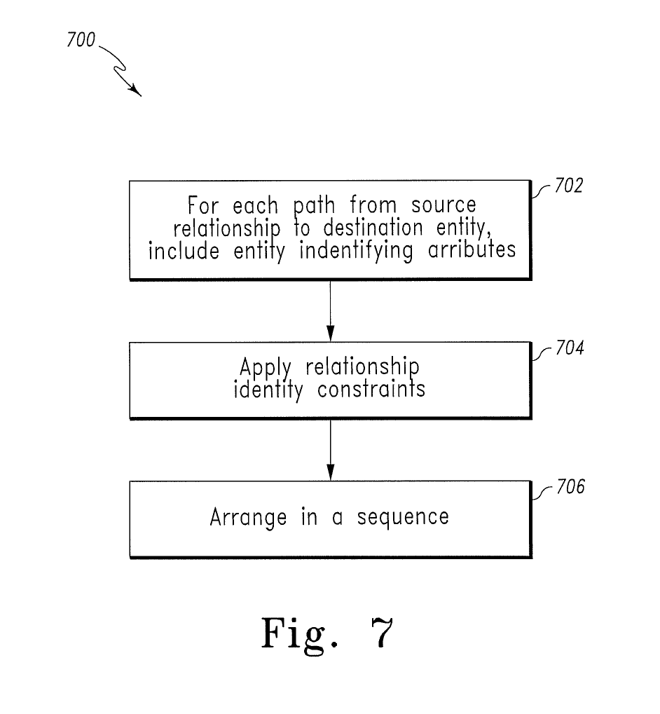

FIG. 7 is a flow chart showing a method 700 of generating a relationship key according to one embodiment of the present invention. At 702, for each path from the source relationship to the destination entity, an identifying attribute of every intermediate entity in the path is included. For example, there are two paths from relationship 304b in FIG. 3 to the destination entity (system entity 302a, in this example.) The first path contributes identifying attributes 306e (flies.flightNumber) and 306d (flies.isPartOf.airlineCode). The second path contributes identifying attributes 306b (isFlownBy.aircraftNumber) and 306d (isFlownBy.isOwnedBy.airlineCode) As with entity key generation, the key elements include the links indicating the path taken from the source relationship. At 704, identity constraints, if any, are applied. The identity constraint discussed above for relationship 304b is flies.isPartOf=isFlownBy.isOwnedBy. This implies that key elements flies.isPartOf.airlineCode and isFlownBy.isOwnedBy.airlineCode are equal. Therefore, one of the two is eliminated. At 706, the remaining key elements are arranged in a sequence. Any sequence is acceptable. However, for clarity, the elements in this example are arranged with the attributes closest to the destination entity first. The key sequence for relationship 304b is, therefore, [flies.isPartOf.airlineCode, flies.flightNumber, isFlownBy.aircraftNumber]. This key sequence will uniquely identify relationship 304b based on attribute values alone.

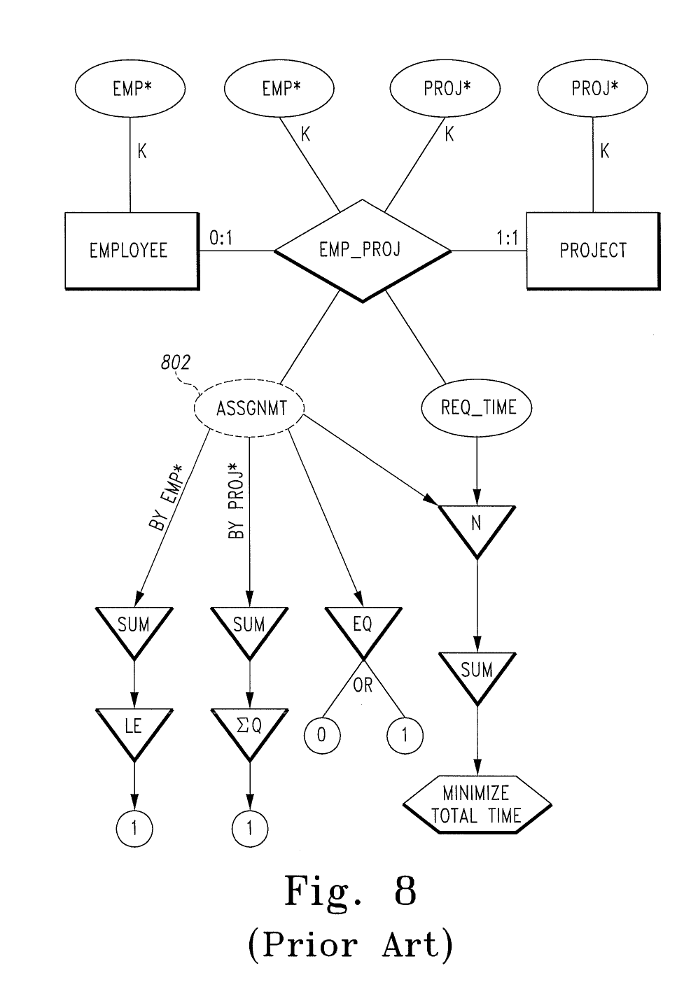

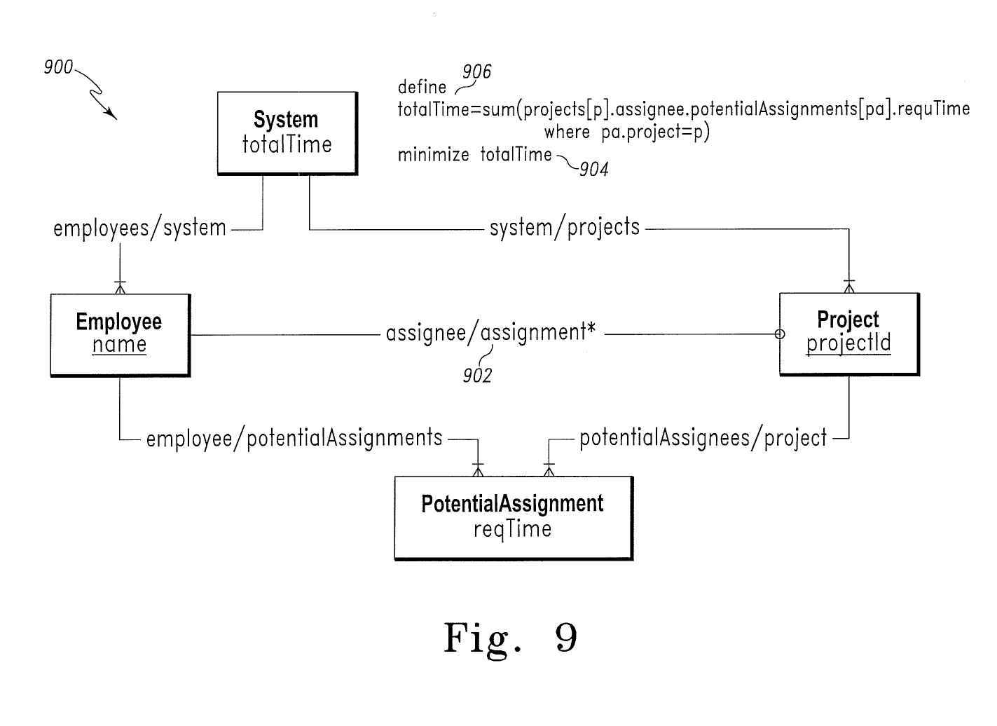

In order to illustrate some of the advantages of embodiments of the present invention over other methods of representing optimization problems graphically, FIGS. 8 and 9 are presented for comparison. FIG. 8 is a diagram illustrated in an article by J. Choobineh entitled “A Diagramming Technique for Representation of Linear Models.” Omega Int. J. of Mgmt. Sci., Vol. 19, No. 1, pp. 43-51, 1991. FIG. 9 is a diagram 900 produced according to embodiments of the present invention for the same linear problem. The decision variable in FIG. 8 is attribute 802 and is represented by the dotted ellipse. The problem being represented is the minimization of the total time for employees to finish a set of projects. The diagram of FIG. 8 can only use attributes as decision variables and uses unique structure and symbology developed by Choobineh. FIG. 9, however, represents the decision variable in a more intuitive manner by designating the relationship 902 as the decision element, as indicated by the asterisk. Also included in FIG. 9 are the objective function 904 and a constraint 906. As can be seen, the diagram of FIG. 9 is much easier to understand, less cluttered, and represents the problem in a more intuitive way.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of determining a solution to a problem, the method comprising:
defining a problem graphically using an entity-relationship modeling notation comprising at least one entity, at least one attribute, and at least one relationship, wherein the at least one entity and the at least one relationship are capable of being designated as a decision element;
mapping the graphical modeling notation to algebraic form; and
passing the algebraic form to a mathematical solver adapted to solve the algebraic form of the problem.

2. The method of claim 1, further comprising:
retrieving instance data for one or more non-decision elements from one of a relational database and explicit user input during definition of the problem.

3. The method of claim 1, further comprising at least one of:
generating an entity key for the at least one entity to identify each entity using entity attribute values alone; and
generating a relationship key for the at least one relationship to identify each relationship using entity attribute values alone.

4. The method of claim 3, wherein generating an entity key for the at least one entity further comprises:
including at least one identifying attribute of the at least one entity as an element of the entity key;
including, as an element of the entity key, at least one identifying attribute of each intermediate entity along each path from the entity to a destination entity;
applying entity identity constraints to remove redundant elements of the entity key; and
arranging the remaining elements of the entity key in a sequence.

5. The method of claim 3, wherein generating a relationship key for each relationship further comprises:
including, as an element of the relationship key for the at least one relationship, at least one identifying attribute of each intermediate entity along each path from the relationship to a destination entity;
applying relationship identity constraints to remove redundant elements of the relationship key; and
arranging the remaining elements of the relationship key in a sequence.

6. The method of claim 1, wherein mapping the graphical modeling notation to algebraic form further comprises:
mapping each enumerated data type used by identifying attributes to an index set;
mapping each decision entity to a binary decision variable;
mapping each decision relationship to a binary decision variable; and
mapping each decision attribute to a decision variable of the same data type as the decision attribute.

7. The method of claim 1, wherein mapping the graphical modeling notation to algebraic form further comprises:
mapping each non-identifying non-decision relationship to a binary parameter;
mapping each non-identifying non-decision entity to a binary parameter; and
mapping each non-identifying non-decision attribute to a parameter of the same data type as the non-identifying non-decision attribute, wherein the parameter values are defined by the instance data.

8. The method of claim 1, wherein mapping the graphical modeling notation to algebraic form further comprises:
generating a constraint for each non-identifying link that has a maximum degree of one to enforce the maximum degree;
generating a constraint to enforce referential integrity for each identifying link; and
generating two referential integrity constraints for each non-identifying relationship to ensure that relationship instances link only entity instances that actually exist.

9. The method of claim 1, wherein defining a problem graphically using an entity-relationship modeling notation further comprises defining a problem graphically using the Logical Data Structures (LDS) modeling notation.

10. A system for determining a solution to a problem, the system comprising:
a display element adapted to display graphical modeling notation;
at least one user input element adapted to receive user input in defining a problem using the graphical modeling notation; and
a processing unit coupled to the display element and to the at least one user input element, the processing unit being adapted to send display signals to the display element to display the problem using the graphical modeling notation based on input received from the user input element, the processing unit being further adapted to map the graphical modeling notation of the problem to algebraic form, wherein at least one of an entity and a relationship in the graphical modeling notation are designated as a decision element based on user input.

11. The system of claim 10, further comprising:
a relational database coupled to the processing unit, wherein the processing unit is adapted to obtain instance data from the relational database.

12. The system of claim 10, wherein the processing unit is further adapted to generate an entity key and a relationship key for each entity and relationship, respectively, in the graphical modeling notation.

13. The system of claim 12, wherein the processing unit is further adapted to include at least one identifying attribute of a source entity and at least one identifying attribute of each intermediate entity along each path from said source entity to a destination entity as elements of the entity key for said source entity, the processing unit being further adapted to apply entity identity constraints to remove redundant elements of the entity key, and to arrange the remaining elements of the entity key in a sequence.

14. The system of claim 12, wherein the processing unit is further adapted to include at least one identifying attribute of each intermediate entity along each path from a source relationship to a destination entity as elements of the relationship key for said source relationship, the processing unit being further adapted to apply relationship identity constraints to remove redundant elements of the relationship key, and to arrange the remaining elements of the relationship key in a sequence.

15. A computer program product, comprising:
a computer-usable medium having computer-readable code embodied therein for configuring a computer processor, the computer-readable code comprising:
first executable instructions configured to cause a computer processor to map a problem described using graphical modeling notation to algebraic form, wherein at least one of an entity and a relationship in the graphical modeling notation is designated as a decision element; and
second executable instructions configured to cause a computer processor to pass the algebraic form to a mathematical solver adapted to determine a solution to the algebraic problem.

16. The computer program product of claim 15, wherein the first executable instructions further comprise executable instructions configured to cause a computer processor to:
generate an entity key for each entity in the graphical modeling notation to identify each entity using entity attribute values alone; and
generate a relationship key for each relationship in the graphical modeling notation to identify each relationship using entity attribute values alone.

17. The computer program product of claim 16, wherein the first executable instructions configured to cause a computer processor to generate an entity key further comprise executable instructions configured to cause a computer processor to:
include at least one identifying attribute of a source entity as an element of the entity key;
include, as an element of the entity key, at least one identifying attribute of each intermediate entity along each path from the source entity to a destination entity;
apply entity identity constraints to remove redundant elements of the entity key; and
arrange the remaining elements of the entity key in a sequence.

18. The computer program product of claim 16, wherein the first executable instructions configured to cause a computer processor to generate a relationship key further comprise executable instructions configured to cause a computer processor to:
include, as an element of the relationship key for a source relationship, at least one identifying attribute of each intermediate entity along each path from the source relationship to a destination entity;
apply relationship identity constraints to remove redundant elements of the relationship key; and
arrange the remaining elements of the relationship key in a sequence.

19. The computer program product of claim 15, wherein the first executable instructions further comprise executable instructions configured to cause a computer processor to:
map each enumerated data type used by identifying attributes to an index set;
map each decision entity to a binary decision variable;
map each decision relationship to a binary decision variable; and
map each decision attribute to a decision variable of the same data type as the decision attribute.

20. The computer program product of claim 15, wherein the first executable instructions further comprise executable instructions configured to cause a computer processor to:
generate a constraint for each non-identifying link that has a maximum degree of one to enforce the maximum degree;
generate a constraint to enforce referential integrity for each identifying link; and
generate two referential integrity constraints for each non-identifying relationship to ensure that relationship instances link only entity instances that actually exist.
